(19) United States
(12) Patent Application Publication
(10) Pub. No.: US 2014/0278670 A1
(43) Pub. Date: Sep. 18, 2014

(54) METHOD FOR IDENTIFYING PEOPLE TO MEET

(71) Applicant: Yakov Z. Mermelstein, Spring Valley, NY (US)

(72) Inventor: Yakov Z. Mermelstein, Spring Valley, NY (US)

(21) Appl. No.: 13/800,058

(22) Filed: Mar. 13, 2013

(51) Int. Cl. G06Q 10/10

(52) U.S. Cl. CPC G06Q 10/1095
USPC 705/7.19

(57) ABSTRACT

The herein method involves electronically searching for people with a certain characteristic. Once these people are identified, then there is a search of to see if there is a common available time for a meeting, both with respect to time and location.

### FIELD OF THE INVENTION

This invention relates to the electronics and communications industry and, more particularly, to an electronic system for helping a person find relevant people to meet.

### BACKGROUND OF THE INVENTION

In today's busy world, people are moving constantly. No one sits still anymore. This week, there is a conference in Las Vegas, and next week a trade show in Chicago. Along the way, you have people to meet in New York and elsewhere.

Especially while traveling, people need to be able to identify people they need to meet. Sometimes, they may be people who are already known, and other times they may be entirely new and unknown.

Therefore, there is a need in the industry for people to more quickly and efficiently identify the people they want and/or need to meet.

### SUMMARY OF THE INVENTION

These and other objects of the invention are achieved with a method involving electronically searching for people with a certain characteristic. Once these people are identified, then there is a search to see if there is a common available time for a meeting, both with respect to time and location.

According to the Invention, the method for facilitating scheduling of meetings, comprises: Identifying potential persons for a meeting and establishing electronic communications between an initiator of the meeting and these potential persons; Identifying a location for each day in a designated time frame on an electronic calendar of the initiator and the potential persons; Defining a characteristic for persons with whom a meeting shall be held; Searching potential persons to identify persons with this characteristic; Searching an electronic calendar of these persons with the characteristic and also the initiator to identify a common meeting availability with respect to both time and location availability.

If a match is made, a meeting can automatically be set on the calendar.

Other objects, features and advantages of the present invention will become apparent upon reading the following detailed description in conjunction with the drawings and the claims.

### BRIEF DESCRIPTION OF THE DRAWINGS

For a better understanding of the invention, its operation and specific objects attained by its uses, reference should be had to accompanying drawings and descriptive matter in which there are illustrated preferred embodiments of the invention

The invention will now be described in connection with certain preferred embodiments with reference to the following illustrative figures so that it may be more fully understood.

FIG. 1 is a flow chart, showing the process of the invention

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to the Invention, in its simplest, basic form, it involves electronically searching for people with a certain characteristic. Once these people are identified, then there is a search to see if there is a common available time for a meeting, both with respect to time and location.

In the preferred embodiment of the invention, the method for facilitating scheduling of meetings, comprises: Identifying potential persons for a meeting and establishing electronic communications between an initiator of the meeting and these potential persons; Identifying a location for each day in a designated time frame on an electronic calendar of the initiator and the potential persons; Defining a characteristic for persons with whom a meeting shall be held; Searching potential persons to identify persons with this characteristic; Searching an electronic calendar of these persons with the characteristic and also the initiator to identify a common meeting availability with respect to both time and location availability.

If a match is made, a meeting can automatically be set on the calendar. The initiator can override an automatic meeting entry on his calendar. This is helpful in case the initiator prefers a different meeting or just does not want to meet that person for whatever reason.

Initially, as a first step in this system, there must be a channel of electronic communication between a person and potential meeting attendees. This is as simple as both being part of the same local area network (such as an intra-company network) or even both being connected to the Internet.

Since this whole system of identifying meeting availability requires the people to be at a common location (or at least in a close vicinity), there is a need for each participant to have his location set on his personal electronic calendar. Without this information, the system cannot determine if two people have availability since their locations would be unknown.

Therefore, each participant needs to set a daily location for each day that he wants to be available for meetings. If desired, a default location can be set. For example, if the participant does not set a location for a particular day, then a predefined location (such as home city) is entered.

Many electronic calendar programs, like Microsoft's Outlook, have a feature that allows users to set the location for meetings or for a certain time frame.

Once there is a channel of communication and the participants set their locations, the person who wants to initiate meetings needs to identify some characteristic of the person he wants to meet.

In some cases, this characteristic is shared by both the initiator and the potential persons to meet. For example, the initiator may be in the diamond business. He may want to identify all other people in the diamond business who are in New York or Amsterdam or Tel Aviv at the same time. This why he can arrange meetings with them. He could be a salesman for clothing and he may want to identify buyers of clothing.

The characteristic can include titles, company affiliation, company position, conference name, attribute, profession, industry and/or location. This way you can search for representatives of a specific company. You can restrict the search to just CEOs or Buyers or other relevant people. A specific profession or industry can be targeted.

There may also be a productivity rating for the persons with said characteristic. In this way, the initiator can limit his meeting to just those people with high productivity and exclude less efficient people.

The initiator can establish a prioritization protocol. For example, he may prefer CEOs to Buyers. He can set the order or priority, based on any criteria. In this way, meetings will be set with the most meaningful people first.

Another possibility is the initiator defines a characteristic of persons he would like to meet. For example, he may be traveling overseas and get a toothache while in Zurich. Thus, he wants to identify dentists in Zurich who have matching availability. In such a situation, the characteristic is not indicative of said initiator; but, is indicative of the person who the initiator wants to meet.

It is possible to identify the persons with the characteristic in the order in which they are available. In this way, for example, the initiator can see, for example, which dentist is available first.

Once the defining characteristic is defined, the system searches through the persons with whom there is a communication link to identify persons with this characteristic. This is a standard search protocol. What is different from current searches is that the search is of another person's calendar and, after the search, entries are automatically made on the initiator's calendar and, sometimes, also on the calendars of the identified persons.

After the matching people are found, the system searches the electronic calendar of these persons with the characteristic and also the initiator to identify a common meeting availability with respect to both time and location availability. Here is it important for the search to be for both criteria. It does not matter of there is a common open time slot, if they are not located geographically close to each other. If the time slot is open for both people, but one is in Tel Aviv and the other is in London at that time, there is no match. The match must be with respect to both time and location

If a match is made, a meeting can be automatically set on their respective calendars, or just the availability may be marked on the initiator's calendar.

According to an alternate embodiment, the system identifies a time frame having a greatest number of common meeting availabilities. After doing the search, the system highlights how many matches there are in selected time frames. For example, April 1 to 10 may have 12 available meeting, but April 11 to 20 may have 20 available meetings. In this way, the initiator can determine the best time to travel.

Another alternative would be to see how much time is needed to set meetings with all the identified persons. For example, suppose a person wished to travel to Shanghai to meet cell phone manufacturers. The user would designate cell phone manufacturers as the characteristic. Then, the system would determine available meeting dates and determine precisely how long the user would need to travel in order to fit in all the meetings. By way of example, the system may determine it will take a month to fit in all these meetings, based on searching the electronic calendars of the involved people.

Another alternate embodiment is for the initiator to identify a time frame for meetings. In this way, the initiator selects when to travel and the system tells him who is available.

Still another embodiment is for the initiator to identify a time frame when he will be in a certain location. For example, he may be in Hong Kong during April. Then, based on the characteristic, the system identified all persons who can be available to meet in Hong Kong during April.

Another possible embodiment allows the initiator to be advised of the potential participant's location even though there is no meeting availability. For example, an initiator may be trying to set a meeting with a friend, but there is no meeting availability during the selected time frame. Instead the initiator receives back a communication that the person is, for example, in London.

Stated succinctly, the system serves as a type of social filter. The user identifies some feature or characteristic of a person (or persons) he wants to meet, and then the system identifies these people, including common available open time slots in the same location. This why it enables people to quickly identify people they want to meet, and to set up meetings.

Searching of databases and application files is known in the trade.

In computer science, a search data structure is any data structure that allows the efficient retrieval of specific items from a set of items, such as a specific record from a database.

The simplest, and least efficient, search structure is merely an unordered sequential list of all the items. Locating the desired item in such a list, by the linear search method, inevitably requires a number of operations proportional to the number n of items, in the worst case as well as in the average case. Useful search data structures allow faster retrieval; however, they are limited to queries of some specific kind.

Static search structures are designed for answering many queries on a fixed database. Dynamic structures also allow insertion, deletion, or modification of items between successive queries. In the dynamic structure, one must also consider the cost of fixing the search structure to account for the changes in the database.

The simplest kind of query is to locate a record that has a specific field (the key) equal to a specified value v. Other common kinds of query are “find the item with smallest (or largest) key value”, “find the item with largest key value not exceeding v”, “find all items with key values between specified bounds vₘᵢₙ and vₘₐₓ”.

In certain databases the key values may be points in some multi-dimensional space. For example, the key may be a geographic position (latitude and longitude) on the Earth. In that case, common kinds of queries are find the record with a key closest to a given point v″, or “find all items whose key lies at a given distance from v”, or “find all items within a specified region R of the space.”

There are several categories of search engine software: Web search or full-text search, database or structured data search, and mixed or enterprise search. The largest web search engines such as Google and Yahoo! utilize tens or hundreds of thousands of computers to process billions of web pages and return results for thousands of searches per second. The high volume of queries and text processing requires the software to run in a highly distributed environment with a high degree of redundancy.

Searching for text-based content in databases or other structured data formats (XML, CSV, etc.) presents some special challenges and opportunities which a number of specialized search engines resolve. Databases are slow when solving complex queries with multiple logical or string matching arguments. Databases allow logical queries which full-text search do not (use of multi-field Boolean logic for instance). There is no crawling necessary for a database since the data is already structured, but it is often necessary to index the data in a more compact form designed to allow for faster search.

Database search engines were initially (and still usually are) included with major database software products. As such, they are usually called indexing engines.

In more advanced Database search systems, relational databases are indexed by compounding multiple tables into a single table containing only the fields that need to be queried (or displayed in search results). The actual data matching engines can include any functions from basic string matching, normalization, and/or transformation.

According to the herein Invention, the key word(s) are determined based on the search characteristic of the person(s) that are to be identified. From there it is like any other search. Thus, the unique, inventive aspect is the concept of the system automatically determining the key words to use to identify the relevant people, and then searching the electronic calendars to find available meeting times, based both on time and location.

As described herein, the user defines a characteristic for persons with whom a meeting shall be held. Then the system, using conventional, known search protocols, identifies persons with this characteristic. Thereafter, the system searches electronic calendars of these persons and also the user to identify a common meeting availability with respect to both time and location availability.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. A method for facilitating scheduling of meetings, comprising:
A. Identifying potential persons for a meeting and establishing electronic communications between an initiator of said meeting and said potential persons;
B. Identifying a location for each day in a designated time frame on an electronic calendar of said initiator and said potential persons;
C. Defining a characteristic for persons with whom a meeting shall be held;
D. Searching potential persons to identify persons with said characteristic;
E. Searching an electronic calendar of said persons with said characteristic and said initiator to identify a common meeting availability with respect to both time and location availability.

2. A method according to claim 1, further comprising automatically setting a meeting on said electronic calendars of said initiator and said persons with said characteristic, based on said time and location availability.

3. A method according to claim 2, wherein said initiator can override an automatic meeting entry on his calendar.

4. A method according to claim 1, wherein said characteristic is shared by both said initiator and said potential persons.

5. A method according to claim 1, wherein said initiator defines a characteristic of persons he would like to meet.

6. A method according to claim 1, further comprising identifying said persons with said characteristic in an order in which they are available.

7. A method according to claim 1, wherein said characteristic is not indicative of said initiator.

8. A method according to claim 1, wherein said initiator and said potential persons set a default location for themselves on their respective electronic calendars.

9. A method according to claim 1, wherein said initiator being advised of a location of said potential person.

10. A method according to claim 1, wherein after searching an electronic calendar of said persons with said characteristic and said initiator to identify common meeting availability with respect to both time and location availability, said meeting availability is marked on an electronic calendar of said initiator and an actual meeting is not set on the calendars of said persons with said characteristic.

11. A method according to claim 1, wherein said initiator establishes a prioritization protocol.

12. A method according to claim 1, wherein said characteristic including titles, company affiliation, company position, conference name, attribute, profession, industry and/or location.

13. A method according to claim 1, further comprising a productivity rating for said persons with said characteristic.

14. A method according to claim 1, further comprising identifying a necessary time frame for all common meeting availabilities.

15. A method according to claim 1, further comprising identifying a time frame having a greatest number of common meeting availabilities.

16. A method according to claim 1, further comprising said initiator identifying a time frame for meetings.

17. A method according to claim 1, wherein said initiator identifies a time frame when he will be in a certain location.
